(19) United States
(12) Patent Application Publication
(10) Pub. No.: US 2024/0078681 A1
(43) Pub. Date: Mar. 7, 2024

(54) TRAINING OF INSTANT SEGMENTATION ALGORITHMS WITH PARTIALLY ANNOTATED IMAGES

(71) Applicant: Carl Zeiss Microscopy GmbH, Jena (DE)

(72) Inventors: Simon FRANCHINI, München (DE); Sebastian SOYER, München (DE)

(21) Appl. No.: 18/240,461

(22) Filed: Aug. 31, 2023

(30) Foreign Application Priority Data
Sep. 1, 2022 (DE) 102022209113.2

(51) Int. Cl. G06T 7/12; G06T 7/60; G06V 10/25; G06V 10/764; G06V 20/70

(52) U.S. Cl. CPC G06T 7/12; G06T 7/60; G06V 10/25; G06V 10/764; G06V 20/70; G06T 2207/10056; G06T 2207/20084

(57) ABSTRACT

A method for training a machine learning model for the instance segmentation of objects in images, in particular microscope images. The first work step is the inputting of a partially annotated image with a first annotated area, whereby regions of objects in the first annotated area of the partially annotated image are assigned to an object class and regions without objects are assigned to a background class. Labeling of the image, particularly in its entirety, is realized by the machine learning model in the next step, whereby regions of objects predicted by the machine learning model are assigned to the object class. A loss function value of the machine learning model is thereafter calculated by matching annotations related to the first annotated area to corresponding labels. In the last work step, the machine learning model is adapted such that the loss function is minimized to the greatest extent possible.

### RELATED APPLICATIONS

The present application is a U.S. National Stage application of German Application No. DE 102022209113.2 filed Sep. 1, 2022, the contents of each are incorporated by reference in their entirety.

### FIELD OF THE INVENTION

The invention relates to a method and system for training a machine learning model for the instance segmentation of objects in images, in particular microscope images. The invention moreover relates to a method and system for the instance segmentation of images by means of a machine learning model.

### BACKGROUND OF THE INVENTION

With conventional microscopes, a sitting or standing user views a sample carrier through an eyepiece. He is thereby able to interact directly with the sample in that, on the one hand, he can get a cursory overview of the field of view of the objective, in particular of the sample carrier, the position of coverslips and of samples and, on the other hand, he can laterally move the sample carrier with the sample either directly or with the aid of an adjustable sample stage in order to bring other areas of the sample carrier into the field of view of the objective. As the user of the microscope can thereby remain in his position and only needs to move his head slightly, conventional microscopes are highly ergonomic in this regard.

Today's microscope systems, however, allow so-called flash stacks to be recorded along an observation direction and a spatial image of a sample to be reconstructed therefrom. To that end, images are produced using detectors. Detectors can be, for example, cameras equipped with appropriate surface sensors, in particular CCD chips, or also so-called photomultipliers.

The working environment has therefore shifted away from the microscope stand in these new microscope systems, and thus away from the sample, to the computer or to the screen of same respectively. Yet the working environment in front of the microscope stand is still often used and also needed in order to prepare or position the sample carrier or sample for analysis.

This involves the work steps:
bringing the sample carrier into the view field of the objective;
selecting a region on the sample carrier in which a sample is arranged;
approaching same; and
ultimately focusing the microscope on the sample carrier or sample.

The workload when using modern complex microscope systems thus frequently involves two work spaces at which differing work steps take place and which are spatially separated from one another. On the one hand, the microscope stand with the eyepiece for direct observation and, on the other, the monitor screen of a computer.

Document DE 10 2017 111 718 A1 relates to a method for producing and analyzing an overview contrast image of a sample carrier and/or samples arranged on a sample carrier in which a sample carrier arranged at least partially in the focus of a detection optical unit is illuminated in transmitted light using a two-dimensional, array-like illumination pattern, wherein at least two overview raw images are detected under different illuminations of the sample carrier and an allocation algorithm is selected as a function of information to be extracted from the overview contrast image, by means of which the at least two overview raw images are allocated to the overview contrast image and an image evaluation algorithm is selected as a function of information to be extracted from the overview contrast image, by means of which the information is extracted from the overview contrast image.

The “Robust Nucleous Detection with Partially Labelled Exemplars” publication, Linquing Feng et al., IEEE Access, 2019, Vol. 7, pages 162169-162178, relates to a method for the automatic characterization of cells in images using deep convolutional networks.

### Aspects and Embodiments of the Invention

A task of the invention is that of improving, in particular automating, identification of objects in a microscope image.

This task is solved by a method and system for training a machine learning model for the instance segmentation of objects and images in accordance with the independent claims. Advantageous embodiments are claimed in the dependent claims.

A first aspect of the invention relates to a method for training a machine learning model for the instance segmentation of objects in images, in particular microscope images, preferably comprising the following work steps:
a. inputting a partially annotated image with a first annotated area, whereby regions of objects in the first annotated area of the partially annotated image are assigned to an object class and regions without objects are assigned to a background class;
b. labeling the image, particularly its entirety, via the machine learning model, whereby regions of objects predicted by the machine learning model are assigned to the object class;
c. calculating a loss function value of the machine learning model by matching annotations related to the first annotated area (4) to corresponding labels; and
d. adapting the machine learning model so as to minimize the loss functions.

A second aspect of the invention relates to a computer-implemented machine learning model, in particular an artificial neural network, for the instance segmentation of objects in images, in particular microscope images, wherein the machine learning model is configured so as to realize the work steps of a method for training a machine learning model for the instance segmentation of objects in images, in particular microscope images, for each of a plurality of training inputs.

A third aspect of the invention relates to a computer-implemented method for the instance segmentation of objects in images, in particular microscope images, having the following work steps:
inputting an image;
labeling the image, particularly its entirety, via the machine learning model; and
outputting the labeled image.

A fourth aspect of the invention relates to a system for training a machine learning model for the instance segmentation of objects in images, in particular microscope images, comprising:
a first interface for inputting a partially annotated image with a first annotated area, whereby regions of objects in the first annotated area of the partially annotated image are assigned to an object class and regions without objects are assigned to a background class;
means configured to label the image, particularly its entirety, via the machine learning model, whereby regions of objects predicted by the machine learning model are assigned to the object class;
means configured to calculate a loss function value of the machine learning model by matching annotations to labels in the first annotated area; and
means configured to adapt the machine learning model so as to minimize the loss function.

A fifth aspect of the invention relates to a system for the instance segmentation of objects in images, in particular microscope images, comprising the following work steps:
a second interface for inputting an image;
means configured to label the image, particularly its entirety, via the machine learning model according to the second aspect of the invention; and
means configured to output the labeled image.

Annotation in the sense of the invention is preferably a storing of information related to regions of an image, particularly within the image.

Labeling in the sense of the invention is preferably a storing of information related to regions of an image, particularly within the image, by means of an algorithm.

Information regarding individual areas or pixels of the image can be stored as metainformation.

Classification in the sense of the invention is preferably an assigning of classes.

Segmenting in the sense of the invention is preferably an assigning of each pixel of an image to a specific class.

Instance segmentation in the sense of the invention is the assigning of an image's pixels to one or more instances of one or more classes. Preferably, object masks are generated during instance segmentation.

A loss function in the sense of the invention preferably indicates the degree to which a machine learning model's prediction deviates from an actual situation (“ground truth”) and is used to optimize parameters, in particular associative weighting factors and influencing values (“weights and biases”) of a machine learning model, during training.

Regions in the sense of the invention are part of an area of an image. Regions can thereby be both spatially separate as well as spatially contiguous.

An artificial neural network in the sense of the invention preferably comprises neurons, wherein each neuron has associative weighting factors and a respective influencing value (weights and biases) which can be changed during training. Preferably, an artificial neural network is configured such that one or more neurons are randomly selected and disabled for each of a plurality of training inputs on the basis of their respective probability and weights are adapted on the basis of a comparison of the artificial neural network output in response to the training input to a reference value.

A means within the meaning of the invention can be designed as hardware and/or software, in particular as a processing unit, particularly a digital processing unit, in particular a microprocessor unit (CPU), preferably data-connected or signal-connected to a memory and/or bus system and/or having one or more programs or program modules. The CPU can be configured to process commands implemented as a program stored in a memory system, capture input signals from a data bus and/or send output signals to a data bus. A memory system can comprise one or more, in particular different, storage media, particularly optical, magnetic solid-state and/or other non-volatile media. The program can be designed so as to embody or be capable of performing the methods described herein such that the CPU can execute the steps of such methods.

The invention is based on the approach of only utilizing partially annotated images to train machine learning models for the task of instance segmentation of all the images.

According to the invention, partially annotated images are input; i.e. images with user-provided instance segmentation and annotation in an area or which are already annotated with the instance segmentation from another source. According to the invention, the annotation is thereby made such that regions of the image which are covered by objects are assigned to an object class and regions of the image with no objects are assigned to a background class.

The same image, but without annotations, then undergoes a labeling process by means of a machine learning model, whereby a labeled image is produced. The model can thereby be a generic machine learning model or a pre-trained machine learning model. During the machine learning model labeling, regions of objects predicted by the machine learning model are also preferably assigned to the object class.

The partially annotated image is then compared to the image labeled by the machine learning model. A loss function value is calculated on the basis of the comparison. The comparison is thereby part of the loss function.

Lastly, the machine learning model used for the labeling is changed or adapted. The preferable goal thereby is optimizing, in particular minimizing, the loss function.

Preferably, so-called evolutionary algorithms are used in adapting the machine learning model, although other algorithms and strategies can also be employed here.

The invention enables training a machine learning model for instance segmentation on the basis of only partial or partly annotated images. Making use of a background class enables significantly increasing the predictive accuracy of the trained machine learning model. It is longer necessary to train using images with all of the objects annotated.

When comparing the annotated area of the partially annotated image to the labeling of same produced by the machine learning model, distinction is made in the machine learning model labeling between so-called “true positives;” i.e. correctly predicted objects, “false positives;” i.e. incorrectly predicted objects, “true negatives;” i.e. correctly predicted regions without objects, and “false negatives;” i.e. incorrectly predicted regions without objects. With respect to regions without objects which were incorrectly predicted, an object is in fact present in reality. By allowing for a background class, particularly the “false negatives” can also be taken into account when training the machine learning model. This leads to a considerable improvement of the training effect when training the machine learning model.

The invention is then particularly advantageous when images having high object density, e.g. microscope images, are to undergo instance segmentation. Such images comprise a very high number of objects compared to everyday images such as, for example, photographs of landscapes or even people.

This results in an enormous data annotation effort if all of the objects in all of the images used to train a machine learning model need to be annotated. It is often not possible to reduce the number of annotated images used in training since objects usually vary more between individual images than within images. Particularly in the case of microscope images, there is often a change in images as a function of time. The invention can be used to illustrate this variance of object properties between the images in the machine learning model.

Preferably, those areas of a partially annotated image exhibiting the largest variance between different images are thereby annotated. Factoring in the variance of annotated objects is important so that the trained machine learning model can instance segment objects in all their shape, size, color, etc.

The invention provides a mechanism for also being able to factor in “false positive” predictions and “false negative” predictions without annotation of an entire image when training a machine learning model for instance segmentation. Overlapping objects can also be systematically differentiated from one another. In particular, annotated areas may inventively be of any form.

In addition, the inventive approach can be used for a plurality of model architectures, e.g. so-called “Region Proposal Networks,” mask R-CNN architectures or Mask2Former architectures. In general, the inventive method is thereby suited to anchor-based machine learning models as well as to non-anchor-based machine learning models.

In one advantageous embodiment, the method for training a machine learning model further comprises the work step e. of checking whether a predetermined abort condition has been met. Work steps b. to d. are preferably repeated until the predetermined abort condition has been met, in particular through a predefined number of repetitions, and/or until the loss function value falls below a predefined value and/or until a change of the loss function value falls below a given threshold and/or an accuracy of the machine learning model falls below a predetermined quality in non-annotated areas of the image or areas only annotated for test purposes.

The repeating of work steps b. to d. until an abort condition enables the iterative training of the machine learning model. The machine learning model can thereby be optimally trained on the basis of a single annotated area. In particular, the annotating effort involved in training the machine learning model can thereby be reduced.

In a further advantageous embodiment, the training method further comprises the following work steps:
f. renewed inputting of the partially annotated image with a second annotated area, whereby regions of objects in the second area of the partially annotated image are assigned to an object class and regions without objects to the background class;
g. renewed labeling of the image by the adapted machine learning model, whereby regions of objects predicted by the adapted machine learning model are assigned to the object class and predicted regions without objects to the background class;
h. renewed calculating of a loss function value of the machine learning model by matching annotations to labels in the first annotated area and in the second annotated area; and
i. renewed adapting of the machine learning model so as to minimize the loss function.

Preferably, the second annotated area is in an area of the image in which the machine learning model did not yield any good results when labeling in work step b. The more purposeful the annotations of this second annotated area are in this respect, the less effort needs to be expended in annotating areas that don't add any value to precision. Ideally, the second annotated area and any potential further annotated areas there may be for which the inventive method is successively implemented therefore preferably only contain individual objects or regions not yet instance-segmented precisely enough.

In a further advantageous embodiment, the training method further comprises work step j. of renewed checking of whether a predetermined abort condition has been reached, whereby work steps f. to i. are repeated until the predetermined abort condition has been reached, particularly until a predefined number of repetitions has been reached and/or until the loss function value falls below a predefined value and/or until change of the loss function value falls below a predefined threshold and/or an accuracy of the machine learning model falls below a predetermined quality in non-annotated areas of the image or areas only annotated for test purposes.

Here as well, the machine learning model can be iteratively optimized by means of the second annotated area. The information from the second annotated area can in this way be optimally utilized and the annotation effort kept low.

In a further advantageous embodiment of the training method, the loss function depends on the geometric arrangement of the objects predicted by the machine learning model with respect to the first annotated area and/or with respect to the annotated regions, in particular regions of objects, in the first annotated area and/or with respect to the second annotated area of annotated regions, in particular regions of objects.

The geometric arrangement of the predicted objects thereby determines whether the predicted objects are included in a calculation of the loss function value. This ensures that the algorithm of the machine learning model is only rewarded or punished in relation to areas and/or regions which are annotated. Doing so ensures that only areas which are actually annotated are included in the valuation.

In a further advantageous embodiment of the training method, objects predicted by the machine learning model which are assignable to a region of an object in the first annotated area and/or second annotated area are always included in the calculation of the loss function value.

Consequently, predicted objects which are partly located outside of the annotated area albeit assignable to a region of an object can also be included in the loss function. This thereby ensures that substantially correctly predicted objects are always considered in the machine learning model valuation.

In a further advantageous embodiment of the training method, the machine learning model is a “region-based convolutional neuronal network,” wherein “anchors” assignable to the objects in the first annotated area and/or second annotated area are always included in the calculation of the loss function value.

In a further advantageous embodiment of the training method, objects predicted by the machine learning model which are not assignable to any region of an object in the first annotated area are only included in the calculation of the loss function value when the predicted objects at least overlap with the first annotated area, preferentially predominantly overlap with the first annotated area, and most preferentially completely overlap with the first annotated area and/or wherein objects predicted by the machine learning model which are not assignable to any region of an object in the second annotated area are only included in the calculation of the loss function value when the predicted objects at least overlap with the second annotated area, preferentially predominantly overlap with the second annotated area and most preferentially completely overlap with the second annotated area.

“Predominantly” and “mostly” within the meaning of the invention preferably mean more than half, particularly an area.

This thereby ensures that incorrectly predicted objects, i.e. “false positives,” are only incorporated into the machine learning model valuation when it can be ensured that they are not “true positives” of regions of objects outside of the annotated area. This thereby ensures a particularly strong machine learning model valuation.

In a further advantageous embodiment of the training method, the machine learning model is a “region-based convolutional neuronal network” and “anchors” are ignored if their “bounding box” does not at least overlap with the first annotated area, preferentially not predominantly overlap with the first annotated area or, most preferentially, not completely overlap with the first annotated area and/or wherein “anchors” are ignored if their “bounding box” does not at least overlap with the second annotated area, preferentially not predominantly overlap with the second annotated area and, most preferentially, not completely overlap with the second annotated area.

In a further advantageous embodiment of the training method, the annotation includes segmentation and classification.

In a further advantageous embodiment, the training method further comprises the work step of annotation of the first area and/or the second area on the basis of user information.

This thereby ensures that high-quality “ground truth” data is provided to the machine learning model for training.

### BRIEF DESCRIPTION OF THE DRAWINGS

Further features and advantages will be explained in the following description with reference to the figures. These at least partly schematically show:

FIG. 1: a graphic representation of an exemplary embodiment of a method for training a machine learning model;

FIG. 2: a graphic representation of further work steps of the exemplary embodiment of the method for training a machine learning model for the instance segmentation of objects in images;

FIG. 3: a flowchart of the exemplary embodiment for training a machine learning model according to FIGS. 1 and 2;

FIG. 4: a graphic representation of valuation rules of an exemplary embodiment of a loss function;

FIG. 5: a flowchart of an exemplary embodiment of a method for the instance segmentation of objects and images;

FIG. 6: an exemplary embodiment of a system for training a machine learning model for the instance segmentation of objects in images; and

FIG. 7: an exemplary embodiment of a system for the instance segmentation of objects in images.

### DETAILED DESCRIPTION OF THE DRAWINGS

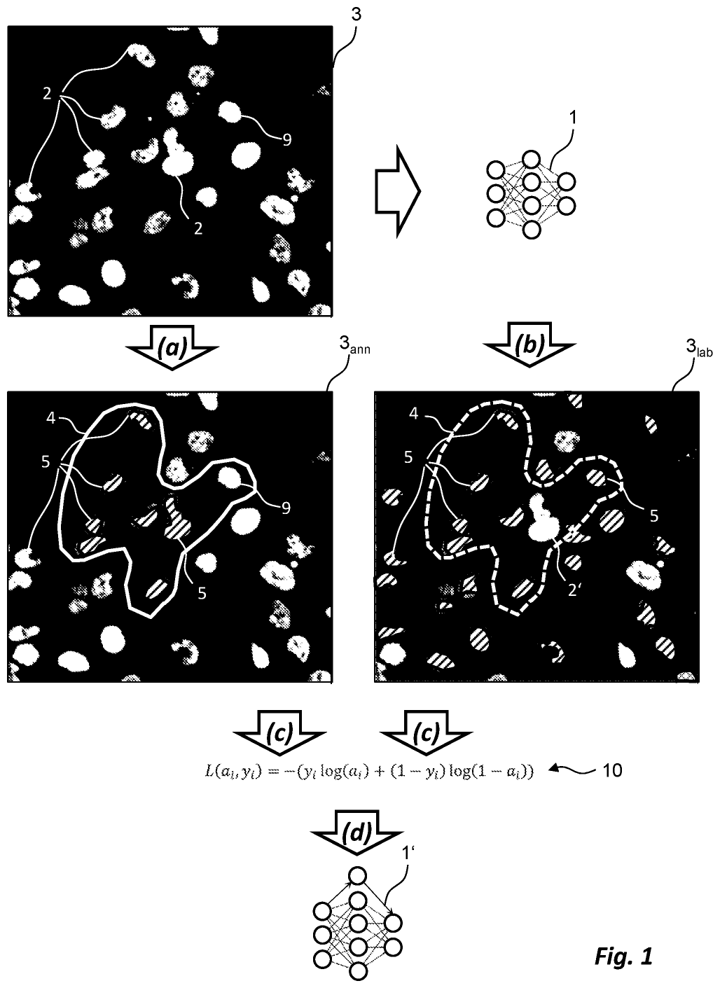

The following will reference FIGS. 1, 2 and 3 in describing an exemplary embodiment of the method 100 for training a machine learning model.

The method is thereby described on the basis of, purely as an example, instance segmentation of microscope images recognizing cells with a cell nucleus and identifying their associated area as a mask.

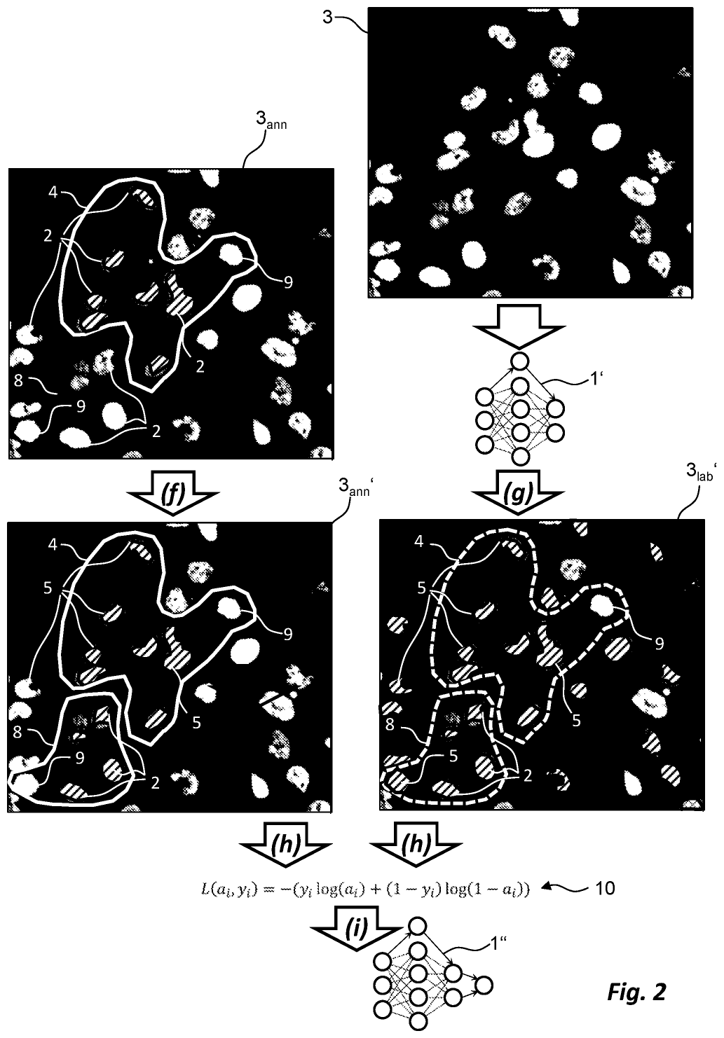

FIG. 1 depicts a microscope image 3 to undergo instance segmentation. Objects 2 and artifacts 9 are present in the microscope image 3. For reasons of clarity, reference symbols are only provided to some of the cells 2 as objects as well as only some of the artifacts 9 in the depicted microscope images of FIGS. 1 and 2.

In a first work step 101, a first area 4 is preferably annotated on the basis of user input. Preferably, the user thereby assigns different classes to different areas in the first area of the microscope image 3 which the user can differentiate between on the basis of their structure, color or other characteristics. He also creates masks for the areas he recognizes as cells.

This partially annotated image is input in a second work step 102, indicated in FIG. 1 by arrow (a).

The input partially annotated image 3ₐₙₙ is depicted with first annotated area 4 in FIG. 1. The identified cells 2 are hatched in this annotated area 4. The user has assigned at least one object class to these annotated cells and annotated their area as a mask. In contrast, the remaining area within the first annotated area 4, also pertaining to artifact 9, is assigned to a background class.

In addition, the microscope image on which the partially annotated image 3ₐₙₙ is based is labeled by the machine learning model 1 to be trained in a third work step 103. To that end, the microscope image 3 is also input separately or the information taken from the partially annotated image 3, preferably in the second work step 102. Preferably, the entire microscope image 3 is thereby annotated by the machine learning model 1. The third work step of labeling 103 is indicated in FIG. 1 by arrow (b).

In labeled image 3_{lab}, the regions of objects predicted by the machine learning model 1 are assigned to the object class and regions without objects are assigned to the background class.

As depicted in image 3_{lab} of FIG. 1, the machine learning model 1 thereby classified artifact 9 as region 5 of a cell. Moreover, an object 2 was not recognized as such and therefore assigned to the background class together with the other regions without objects in image 3_{lab};

As depicted in labeled image 3_{lab}, the machine learning model 1 has labeled the entire microscope image 3.

The area corresponding to the first annotated area 4 of annotated image 3ₐₙₙ is depicted by way of dashes in labeled image 3_{lab} for informational purposes only.

In a fourth work step 104, the data of annotated image 3ₐₙₙ and the data of labeled image 3_{lab} are fed to a loss function (I) of the machine learning model 1. This is depicted in FIG. 1 by arrow (c).

The loss function (I) matches the annotation information relative to the first annotated area 4 to labels from the corresponding area of the labeled image 3_{lab} and calculates a value therefrom which represents a quality of the regions predicted by the machine learning model 1.

The loss function (I) can for example be a so-called “binary cross entropy loss” (see Goodfellow Ian et al., “Deep Learning,” MIT Press 2016). An equation of the “binary cross entropy loss” is shown labeled in FIG. 1 with 10. However, this is to be understood purely as an example. Any other type of loss function known to those skilled in the art can also be used to calculate the value.

In a fifth work step 105, the machine learning model 1 is adapted so as to minimize the loss function (I). This work step is indicated in FIG. 1 by arrow (d).

The machine learning model 1 and the adapted machine learning model 1′ are shown in a purely schematic depiction as an artificial neural network with an additional mid-level neuron. However, this is for illustrative purposes only since algorithms other than artificial neural networks can also be used as a machine learning model 1.

Solely as an example, “Region Proposal Networks,” mask R-CNN architectures or even Mask2Former architectures are conceivable for machine learning model 1. Preferably, deep artificial neural networks are used.

In mask R-CNN architecture, the objects are each represented by way of a bounding box with a class label and a segmentation mask for the area in the bounding box.

On the other hand, the Mask2Former architecture generates a complete segmentation mask of the entire image for a predefined number of candidate objects in each case. This segmentation mask consists of the per-pixel probabilities for the presence of an object. A not necessarily complete mapping of predicted candidate objects to annotated objects occurs (matching) and the following cases can be differentiated:
Object matched with an annotation. In this case, the predicted object factors into the calculation of the loss function.
Object not matched with an annotation. In this case, the following instances are differentiated:
   The signal representing the predicted object is sufficiently stronger within the annotated area than outside of the annotated area. In this case, the predicted object will factor into the calculation of the loss function.
   The signal representing the predicted object is insufficiently stronger within the annotated area than outside of the annotated area. In this case, the predicted object will not factor into the calculation of the loss function.

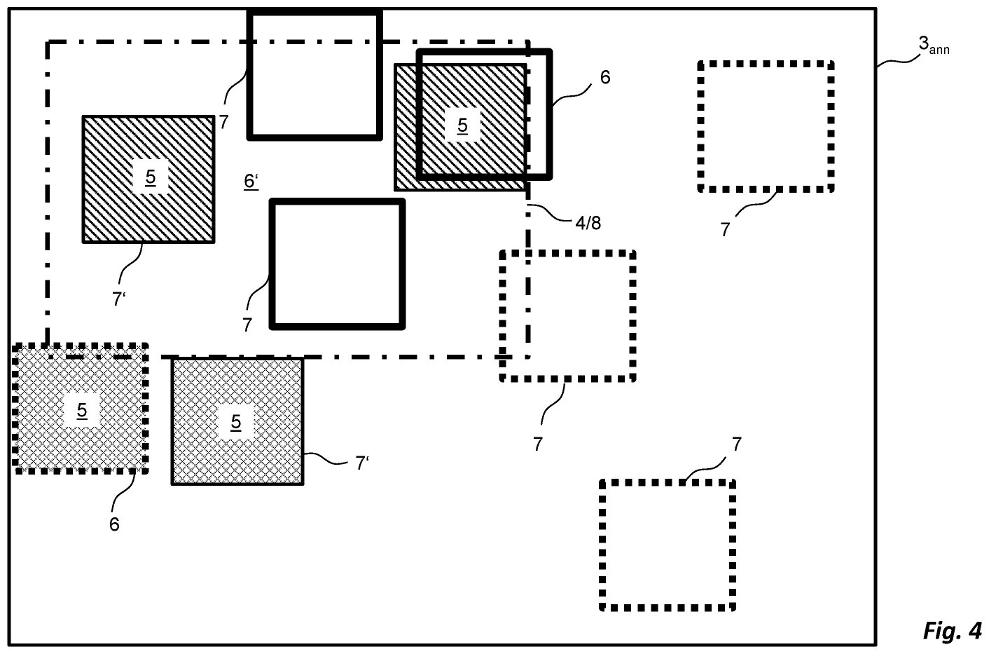

A methodology for evaluating predictions by the loss function will be explained further below with reference to FIG. 4. Generally speaking, however, the value of the loss function depends on the geometric arrangement of the regions 5 of objects within the first annotated area 4 and/or in relation to the annotated regions 5 in the first annotated area 4 predicted by the machine learning model 1. The loss function value furthermore depends on the geometric arrangement of the regions 5 of objects predicted by the machine learning model 1.

A sixth work step 106 is preferably a check as to whether a predetermined abort condition is met.

This abort condition is preferably a predefined number of repetitions of the third work step 103, the fourth work step 104 and the fifth work step 105, further preferably a predefined loss function value which needs to be fallen short of or exceeded to reach the abort condition, further preferably a predefined threshold of a change in the loss function value (gradient) which needs to be fallen short of or exceeded, or further preferably, the falling short of or exceeding a predetermined quality relative to the accuracy of the machine learning model 1 in non-annotated areas of the microscope image 3 or areas annotated for test purposes.

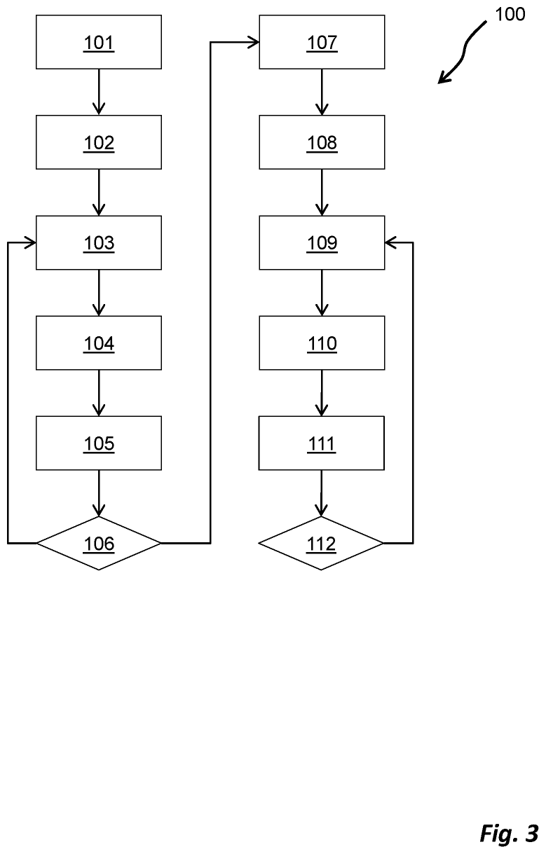

As depicted in FIG. 3, the third, fourth and fifth work step 103, 104, 105 repeat iteratively until the abort condition is met. As a result, the adapted machine learning model 1′ can be optimally used to improve said adapted machine learning model 1′ as long as it continues to be based on the information provided by the first annotated area 4.

Moreover, the already adapted machine learning model 1′ can be further improved by a second annotated area 8 of the microscope image 3 also being included in the optimization.

This part of the method 100 for training the machine learning model 1 is depicted in FIG. 2.

First, preferably a second area of the microscope image 3 is annotated in a seventh work step 107 on the basis of user input. Preferably, this ensues starting with the already annotated image 3ₐₙₙ. The second annotated area is preferably an area of the microscope image 3 in which the machine learning model 1 has had poor labeling results.

This partially annotated image 3_{ann′} with a, particularly additional, second annotated area is input in an eighth work step 108. This work step is indicated in FIG. 2 by arrow (f). The microscope image 3 is provided to the adapted machine learning model 1′ which labels it in a ninth work step 109. This work step is indicated in FIG. 2 by arrow (g). The result of this labeling is illustrated in the labeled image 3_{lab′} in FIG. 2.

The adapted machine learning model 1′ has indeed now correctly predicted an artifact 9 in an area 4 corresponding to the first annotated area and all the objects 5 are also correctly predicted in this area. However, an artifact 9 has been incorrectly recognized as a region 4 of an object in area 8, which corresponds to the second annotated area 8.

A value of the loss function 10 of the adapted machine learning model 1′ is in turn calculated in a tenth work step 110 on the basis of the information from the annotation and the information from the labeling. The information is therefore reconciled again.

In an eleventh work step 111, the already adapted machine learning model 1′ is further adapted so as to further optimize the machine learning model 1′ and minimize the loss function. The aforementioned algorithms can be used to that end. This work step is indicated in FIG. 2 by arrow (i).

Again solely as an example, the thereby resulting further adapted machine learning model 1″ is depicted in FIG. 2 as a symbol of an artificial neural network. Compared to adapted machine learning model 1′, another neuron level has been added therein, again purely as an example.

In a further twelfth work step 112 of the method, it is again checked whether a predetermined abort condition is met. These abort conditions correspond to the above-cited abort conditions as regards the value of the loss function. If this is not the case, the ninth work step 109, tenth work step 110 and eleventh work step 111 are repeated until at least one of the abort conditions is met. This is also depicted again in FIG. 3.

FIG. 4 is a graphic representation of the criteria which the loss function uses to valuate the machine learning model 1 based on the labeled image. Two rules are substantially relevant to the loss function valuation.

The first rule is that of the regions 5 of objects predicted by the machine learning model 1 which are assignable to a region of an object in the first annotated area 4 and/or second annotated area 8 always being included in the calculation of the loss function value.

The first/second annotated area 4/8 is depicted in FIG. 4 by the dashed line. The image on which the depiction is based is an annotated image 3ₐₙₙ. Accordingly, the regions 5 of objects are shown by way of dashing. Two of the regions 5 are thereby within the first/second annotated area 4/8 and are depicted with cross-striping. Two further regions 5 of objects are situated outside of the area 4/8 and are depicted in a checkered pattern.

The thick borderings depicted in FIG. 4 represent the predictions of a machine learning model 1. They are overlain in the annotated image 3ₐₙₙ so as to be able to illustrate the valuation rules of the machine learning model 1. Thick solid edging thereby identifies a prediction included in the loss function valuation. In contrast, thick dotted edging identifies predictions of the machine learning model 1 not included in the loss function valuation.

As can be seen from FIG. 4, the predicted object largely overlapping region 5 of an object in annotated area 4/8 is included in the loss function valuation even though it is partially located outside of the annotated area 4/8. This is because it can be assigned to region 5 of an object. This prediction is thus a “true positive” 6.

A further prediction, which although overlapping with the annotated area 4/8 cannot however be assigned to any region 5 of an object, is left out of the machine learning model 1 valuation. This prediction is a so-called “false positive” 7.

The second rule namely states that the predicted objects of the machine learning model 1 which are unable to be assigned to any region 5 of an object in the first/second annotated area 4/8 will only be included in the loss function value calculation when the predicted objects mostly overlap with the first/second annotated area 4/8. Accordingly, a further depicted incorrect prediction which mostly overlaps annotated area 4/8 is included in the machine learning model valuation as a “false positive” 7.

Although a further prediction of the machine learning model 1 is completely within the first/second annotated area 4/8, none of the regions 5 of objects are assignable. In particular, the prediction overlaps with none of the regions 5 within the first/second annotated area 4/8. Therefore, while the prediction does go into the loss function valuation of the machine learning model 1, it is assessed as a “false positive” 7. Further “false positives” 7 are outside of the first/second annotated area 4/8. These are therefore also not included in the loss function evaluation.

A further object 5 is situated in the first/second annotated area 4/8 although not recognized by the machine learning model 1. This is included in the loss function valuation as a “false negative” 7′.

One of the objects situated outside of the annotated area 4/8 was predicted by the machine learning model 1, thus representing a “true positive” 6, yet is not included in the loss function valuation as it is mostly outside of the annotated area 4/8. Another was not recognized by the machine learning model 1, thus representing a “false negative” 7′, yet was also not taken into account in the loss function valuation since it is outside of the annotated area 4/8.

Those regions of the annotated area 4/8 in which no regions 5 of objects are present and there are no false predictions are classified as “true negative” 6′ and therefore do not contribute to degradation of the loss function value.

“False positives” 7 and “false negatives” 7′ preferably lead to an increase in the loss function, “true positives” 6 and “true negatives” 6′ preferably lead to a decrease in the value of the loss function.

In an alternative embodiment, predicted objects that are not assignable to any region 5 of an object in the first annotated area 4 are then only included in the calculation of the loss function value if the predicted objects at least overlap the annotated area 4/8 or, preferentially, are entirely within the annotated area 4/8.

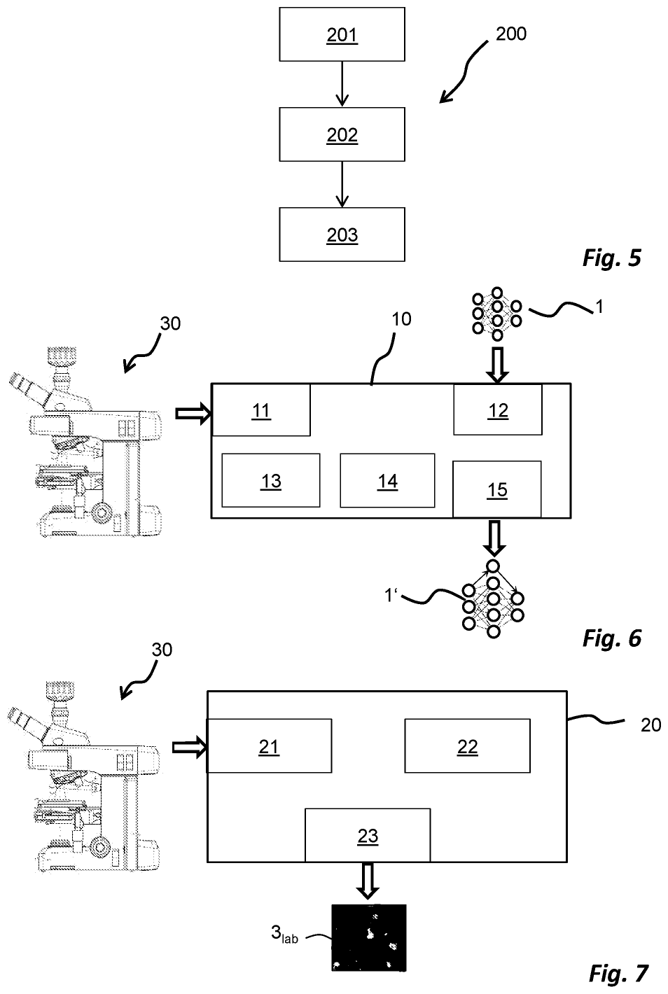

FIG. 5 shows an exemplary embodiment of a method 200 for the instance segmentation of cells 2 in microscope images 3.

The microscope image 3 is input in a first work step 201. In a second work step 202, the microscope image 3, particularly in its entirety, is labeled by a machine learning model 1. The labeled microscope image 3 is output in a third work step 203.

FIG. 6 shows an exemplary embodiment of a system 10 for training a machine learning model 1 for the instance segmentation of cells 2 in microscope images 3.

The system 10 comprises a first interface 11 for inputting a partially annotated microscope image 3ₐₙₙ with a first annotated area 4, whereby regions 5 of objects in the first annotated area 4 of the partially annotated microscope image 3ₐₙₙ are assigned to an object class and regions without objects are assigned to a background class. The first interface 11 can preferably be realized as a data interface or as a camera.

The system 10 further comprises means 12 configured for the labeling of the microscope image 3, particular in its entirety, by the machine learning model 1, wherein regions 5 of objects predicted by the machine learning model 1 are assigned to the object class and predicted regions without objects are assigned to the background class.

The system 10 further comprises means 13 configured for the calculating of a value of a loss function (I) of the machine learning model 1 by matching annotations related to the first annotated area 4 to corresponding labels.

The system 10 preferably further comprises means 14 configured for the adapting of the machine learning model 1 so as to minimize the loss function 10.

Preferably, the machine learning model 1 is in turn output via a second interface 15.

FIG. 7 shows an exemplary embodiment of a system 20 for the instance segmentation of cells 2 in microscope images 3.

The system 20 preferably comprises a third interface 21 for inputting a microscope image 3. The system 20 further comprises means 22 configured for the labeling of the microscope image 3, particular in its entirety, by a machine learning model. Lastly, the system 20 preferably comprises a fourth interface 23 configured to output the labeled microscope image 3.

The microscope images 3 are preferably produced by a microscope 30. Further preferably, such a microscope 30 is a part of the systems 10, 20 for training a machine learning model or for instance segmentation or vice versa.

It should be noted that the exemplary embodiments are only examples which are in no way intended to limit the scope of protection, application and configuration. Rather, the foregoing description is to provide the person skilled in the art with a guideline for implementing at least one embodiment, whereby various modifications can be made, particularly as regards the function and arrangement of the described components, without departing from the scope of protection as results from the claims and equivalent combinations of features. In particular, the annotated area can be of any form.

### LIST OF REFERENCE NUMERALS

1 machine learning model
1′ adapted machine learning model
1″ further adapted machine learning model
2 object
3 image
4 first area
5 region
6 true positive
6′ true negative
7 false positive
7′ false negative
8 second area
9 artifact
10 system
11 first interface
12 means
13 means
14 means
15 second interface
20 system
21 third interface
22 means
23 fourth interface
30 microscope
(I) loss function
3ₐₙₙ annotated image
3_{lab} labeled image

1. A method for training a machine learning model (1) for the instance segmentation of objects in microscope images, comprising the following work steps:
a. inputting a partially annotated image with a first annotated area, whereby regions of objects in the first annotated area of the partially annotated image are assigned to an object class and regions without objects are assigned to a background class;
b. labeling the image, particularly in its entirety, via the machine learning model, whereby regions of objects predicted by the machine learning model are assigned to the object class;
c. calculating a value of a loss function of the machine learning model by matching annotations related to the first annotated area to corresponding labels; and
d. adapting the machine learning model so as to minimize the loss function.

2. The method according to claim 1, further comprising the following work step:
e. checking whether a predetermined abort condition has been met; wherein work steps b. to d. are repeated until the predetermined abort condition has been met, in particular until a predefined number of repetitions has been reached and/or until the loss function value falls below a predefined value and/or until a change of the loss function value falls below a predefined threshold and/or an accuracy of the machine learning model falls below a predetermined quality in non-annotated areas of the image or areas only annotated for test purposes.

3. The method according to claim 1, further comprising the following work steps:
f. renewed inputting of the partially annotated image with a second annotated area, whereby regions of objects in the second area of the partially annotated image are assigned to an object class and regions without objects are assigned to the background class;
g. renewed labeling of the image by the adapted machine learning model, whereby regions of objects predicted by the adapted machine learning model are assigned to the object class;
h. renewed calculating of a value of the loss function of the adapted machine learning model by matching annotations to labels in the first annotated area and in the second annotated area; and
i. renewed adapting of the adapted machine learning model so as to minimize the loss function.

4. The method according to claim 3, further comprising the following work step:
j. checking whether a predetermined abort condition has been met; wherein work steps g. to i. are repeated until the predetermined abort condition has been met, in particular until a predefined number of repetitions has been reached and/or until the loss function value falls below a predefined value and/or until a change of the loss function value falls below a predefined threshold and/or an accuracy of the machine learning model falls below a predetermined quality in non-annotated areas of the image or areas only annotated for test purposes.

5. The method according to claim 1, wherein the value of the loss function depends on the geometric arrangement of the regions of objects predicted by the machine learning model with respect to the first annotated area and/or with respect to the annotated regions, in particular regions of objects, in the first annotated area and/or with respect to the second annotated area and/or with respect to the annotated regions, in particular regions of objects, in the second annotated area.

6. The method according to claim 1, wherein regions of objects predicted by the machine learning model which are assignable to a region of an object in the first annotated area and/or the second annotated area are always included in the calculation of the loss function value.

7. The method according to claim 1, wherein objects predicted by the machine learning model which are not assignable to any region of an object in the first annotated area are only included in the calculation of the loss function value when the predicted objects at least overlap with the first annotated area, preferentially predominantly overlap with the first annotated area, and most preferentially completely overlap with the first annotated area and/or wherein objects predicted by the machine learning model which are not assignable to any region of an object in the second annotated area are only included in the calculation of the loss function value when the predicted objects at least overlap with the second annotated area, preferentially predominantly overlap with the second annotated area, and most preferentially completely overlap with the second annotated area.

8. The method according to claim 1,
further comprising the following work step:
annotation of the first area und/and/or the second area on the basis of user information.

9. The method according to claim 1, wherein objects predicted by the machine learning model for an object class not assignable to any region of an object in the first annotated area and at least overlap with the first annotated area, preferentially predominantly overlap with the first annotated area and most preferentially completely overlap with the first annotated area are considered as being located in a region of the background class and lead to an increase in the loss function value.

10. A computer-implemented machine learning model, in an artificial neural network, for the instance segmentation of objects in microscope images, wherein the machine learning model is configured to realize the work steps of a method according to claim 1 for each of a plurality of training inputs.

11. A computer-implemented method for the instance segmentation of objects in microscope images, comprising the following work steps:
inputting an image;
labeling the image, particularly in its entirety, via a machine learning model according to claim 10; and
outputting the labeled image.

12. A computer program or computer program product, wherein the computer program or computer program product contains commands stored on a computer-readable and/or non-volatile storage medium which, when run on a computer, prompts the computer to execute the steps of the method according to claim 1.

13. A system for training a machine learning model for the instance segmentation of objects in microscope images, comprising:
a first interface for inputting a partially annotated image with a first annotated area, whereby regions of objects in the first annotated area of the partially annotated image are assigned to an object class and regions without objects are assigned to a background class;
means configured to label the image in its entirety, via the machine learning model, whereby regions of objects predicted by the machine learning model are assigned to the object class;
means configured to calculate a value of a loss function of the machine learning model by matching annotations related to the first annotated area to corresponding labels; and
means configured to adapt the machine learning model so as to minimize the loss function.

14. A system for the instance segmentation of objects in microscope images, comprising:
a third interface for inputting an image;
means configured to label the image in its entirety, via the machine learning model according to claim 13; and
a fourth interface configured to output the labeled image.

15. A microscope having a system according to claim 13.

16. A microscope having a system according to claim 14.
